(19) United States
(12) Patent Application Publication
(10) Pub. No.: US 2024/0059320 A1
(43) Pub. Date: Feb. 22, 2024

(54) METHOD FOR MONITORING AT LEAST ONE MOTOR VEHICLE, AND MONITORING SYSTEM

(71) Applicant: AUDI AG, Ingolstadt (DE)

(72) Inventor: Ulrich SINGLE, Ingolstadt (DE)

(73) Assignee: AUDI AG, Ingolstadt (DE)

(21) Appl. No.: 18/251,698

(22) PCT Filed: Sep. 21, 2021
(86) PCT No.: PCT/EP2021/075880

§ 371 Date: May 3, 2023

(30) Foreign Application Priority Data
Nov. 4, 2020 (DE) 10 2020 129 052.7

(51) Int. Cl. B60W 60/00

(52) U.S. Cl. CPC B60W 60/0015; B60W 60/0053; B60W 2556/45

(57) ABSTRACT

A method for monitoring at least one motor vehicle having a vehicle system configured to guide the motor vehicle in a completely automatic manner and a communication device configured to communicate with a remote computing device outside the motor vehicle, wherein, during the completely automatic guidance of the motor vehicle by the vehicle system an item of guidance information describing the completely automatic guidance and an item of vehicle information comprising an item of location information comprising at least a current position of the motor vehicle are transmitted to the computing device. The vehicle information received by the computing device is evaluated together with an item of driving environment information, which is available in the computing device and is based on the position of the motor vehicle, to form an item of status information relating to the motor vehicle. The item of status information and is displayed to a person carrying out the monitoring on a display device. Upon receipt of an item of intervention information from the person carrying out the monitoring via an input device assigned to the display device, the intervention information is transmitted back to the motor vehicle and the motor vehicle is operated to intervene in the completely automatic guidance of the motor vehicle as described by the intervention information.

### TECHNICAL FIELD

The present disclosure relates to a method for monitoring at least one motor vehicle, which comprises a vehicle system designed for completely automatic guidance of the motor vehicle, and a communication device designed for communication with a remote computing device external to the motor vehicle. In addition, the present disclosure relates to a monitoring system for carrying out the method.

### BACKGROUND

An important field of research for motor vehicles is, at present, the operation thereof in a manner that is largely completely automatic, to the greatest extent possible, in particular with regard to the vehicle guidance. Accordingly, vehicle systems that can be used for completely automatic guidance of the motor vehicle at least in certain driving situations or operating situations have already been proposed in the prior art. Such driving functions for completely automatically guiding the motor vehicle are also referred to as autonomous driving functions. In this case, for example, according to SAE J3016, different autonomy stages or “Levels” exist, for example “Level 3” also using a person, in particular the driver, in the motor vehicle for monitoring and as a fallback level.

In order to be able to bring autonomous driving functions as it were “in series,” the highest possible degree of reliability and safety must be provided, which in particular meets corresponding state requirements. A safety concept by way of example, in motor vehicles comprising a vehicle system designed for completely automatic guidance of the motor vehicle, can provide for the provision of a plurality of calculation paths. Usually, the vehicle system processes input data for implementing the autonomous driving function, which data can contain in particular, for example, environmental data recorded by environment sensors of the motor vehicle, ego data describing the operating state of the motor vehicle, and/or further information, in order to generate therefrom, using an algorithm, output data, which relate to vehicle guidance measures and can comprise, for example, control commands. In this regard, a plurality of parallel paths having different algorithms and possibly at least in part different input data can now be used, for example, to increase safety, which are in each case able, independently, to determine suitable output data for completely automatic guidance of the motor vehicle, it being possible for example for the results of different paths to undergo a plausibility check with respect to one another, and/or at least one secondary path can form a fallback level for a main path. In the latter context, a monitoring module can also be provided within the vehicle system, which monitoring module for example monitors the currently used main path for the occurrence of errors, it being possible for the at least one secondary path to take over the complete driving task in the event of an error in the main path. The task of the monitoring module is therefore to monitor whether errors or in general inconsistencies can be determined in one of the paths.

If, for example, it is determined that an unusual or faulty behavior is present in the main path, the monitoring module can initiate the switching of the autonomous driving function from the main path to at least one of the at least one secondary path. In this case, given by way of example, the secondary path will then completely take over the driving task. The prerequisite for switching is that the monitoring module does not identify any unusual behavior in the secondary path.

A safety concept which operates with a plurality of such paths can significantly reduce the probability of a malfunction of autonomous driving functions.

However, other areas in which an improvement of autonomous driving functions can be sought also exist. One of these areas relates to the problem that autonomous driving functions do not yet know certain driving situations/operating situations. In this sense, “experience,” as it were, can therefore be lacking in the vehicle system. Furthermore, the entire knowledge is not always present in the motor vehicle, which would be expedient in the current situation.

DE 10 2015 214 629 A1 relates to a method for controlling a vehicle, in particular an aircraft, train, ship or bus, in which nowadays control systems for autonomous control of the vehicle are increasingly used. Such control systems can take over control of the vehicle at least in certain travel situations, and control said vehicle without intervention by a vehicle driver. It is proposed there to use a central monitoring device arranged outside the vehicle, which device is designed to grant or refuse a command approval for the control commands made in the vehicle. Control commands input by the vehicle driver are forwarded to the central monitoring device and checked automatically there, in order to be able to detect and revise a misuse or incorrect behavior of the vehicle operator.

DE 10 2015 117 280 A1 relates to a locating apparatus for locating a mobile object. Such a mobile object can be a self-propelled or autonomously driving vehicle/motor vehicle which, without human interaction, can in particular change driving states or carry out changes in direction or carry out actions. For persons as objects, it is proposed to monitor them by means of a central monitoring device, it also being possible for the freedom of movement to be determined centrally by paths/regions specified for the respective person, and also to be designed variably.

A device for a vehicle for outsourcing computing power is disclosed by DE 10 2018 009 903 A1. In this case, it is in particular possible to outsource the computing power for the application “highly automated and/or autonomous driving.”

### BRIEF DESCRIPTION OF DRAWINGS/FIGURES

FIG. 1 a monitoring system according to the present disclosure, and

FIG. 2 a schematic view illustrating the course of the method according to the present disclosure.

### DETAILED DESCRIPTION

The present disclosure is based on the object of specifying an improved possibility for monitoring autonomous driving functions, in particular with regard to the introduction of knowledge and empirical values.

In order to achieve this object, it is provided according to the present disclosure, in a method of the type mentioned at the outset, that, during the completely automatic guidance of the motor vehicle by the vehicle system, in particular cyclically,
an item of vehicle information which comprises an item of guidance information describing the completely automatic guidance, and location information containing at least one current position of the motor vehicle, is transmitted to the computing device,
the received vehicle information is evaluated together with an item of driving environment information, which is related to the position of the motor vehicle and is present on the part of the computing device, to form an item of status information of the motor vehicle and is displayed to a person carrying out the monitoring on a display device,
upon receipt of an item of intervention information from the person carrying out the monitoring via an input device assigned to the display device, the intervention information is transmitted back to the motor vehicle and the motor vehicle is operated to intervene in the completely automatic guidance of the motor vehicle as described by the intervention information.

According to the present disclosure, the use of a central location is therefore proposed, at which the autonomous driving is monitored at least in partial aspects, it also being possible for this central location to be referred to as “central monitoring device.” Such a central monitoring device for autonomous driving functions in road traffic can be provided, for example, by a corresponding company, for example a manufacturer which offers the autonomous driving function. For example, the method according to the present disclosure can be used to monitor the use of autonomous driving functions on highways, federal roads, country roads, urban scenarios and/or similar driving environments, but general monitoring for completely automatically guided motor vehicles, for example a vehicle fleet which uses a specific autonomous driving function, is also conceivable.

Specifically, it is provided for this purpose, in a motor vehicle which is automatically guided completely automatically at the time of a time, and which thus has an active autonomous driving function, to transmit regularly, in particular cyclically, for example at intervals of 10 milliseconds to 10 seconds, an item of vehicle information to the computing device of the central monitoring device external to the motor vehicle. This vehicle information describes, on the basis of the guidance information, the completely automatic guidance at least in partial aspects, for example abstracted, but in addition also the location at which the motor vehicle is currently located, on the basis of the location information containing at least one current position of the motor vehicle. However, on the side of the computing device and thus the central, monitored location, the received vehicle information is not directly displayed to a person carrying out the monitoring, but instead is suitably processed for assessment by the person carrying out the monitoring, but in addition also supplemented by driving environment information related to the position of the motor vehicle being additionally taken into account, in order to create enhanced status information in this regard, which can be interpreted particularly easily and in particular also intuitively by a person carrying out the monitoring, at the display device. Therefore, the status information combines the status of the motor vehicle relevant to the assessment of the completely automatic guidance, in particular in as compact a manner as possible, for a human evaluator, namely the person carrying out the monitoring. The person carrying out the monitoring can then decide, on the basis of the status information, whether an intervention in the completely automatic guidance, in particular a termination of the completely automatic guidance, is expedient or even necessary, in which case the person carrying out the monitoring can use an input device assigned to the display device, in order to make an input from which an item of intervention information follows. This is transmitted back to the motor vehicle, the motor vehicle, in particular the vehicle system itself, taking into account the intervention information and automatically executing at least one intervention described by the intervention information.

In this case, a particularly advantageous embodiment of the present disclosure aims at the fact that at least one possible item of intervention information describes a deactivation of the completely automatic guidance by the vehicle system as an intervention. Therefore, the person carrying out the monitoring can decide on the basis of the status information that the active autonomous driving function of the motor vehicle should be switched off. In this regard, the status information can comprise, for example, an item of state information indicating an unusual state of the autonomous driving function and derived from the vehicle information and/or the driving environment information, such that the human person carrying out the monitoring can decide, upon detection of an unusual state of the autonomous driving function, to deactivate said function, for example. However, it is also conceivable, for example, in particular taking into account the driving environment information, to recognize driving situations which are less suitable for the completely automatic guidance by the vehicle system, for example harbor an increased risk for a malfunction. The person carrying out the monitoring can also decide to deactivate the autonomous driving function from the computing device external to the motor vehicle, or generally from the central monitoring device. Finally, the monitoring system created by the present disclosure can be understood similarly to an air space monitoring for monitoring flight traffic in the air space, where aircraft guided by an autopilot can also be monitored, for example. The present disclosure now transfers such an approach to road traffic with motor vehicles.

Of course, other types of intervention information are also conceivable in principle, within the scope of the present disclosure, for example the switching into another operating mode of the vehicle system, which can have, for example, other limits of the autonomous driving function, practice a more careful mode of travel, or the like. Furthermore, it is additionally or alternatively conceivable that the intervention relates to a reduction of the driving speed and/or a maximum permissible driving speed of the motor vehicle. In extreme cases, it can even be conceivable to transfer the motor vehicle into a safe state on the basis of the intervention information, for example standstill on a breakdown lane or at another safe position or a safe location.

In general, it is possible, by means of the method described here, to obtain data, in particular the vehicle information and the driving environment information, by machine, to prepare said data by means of the computing device, by evaluation, and to provide the resulting status information to a human person carrying out the monitoring, for example via a dashboard, in order to thus provide improved, central monitoring for autonomous driving functions.

A large number of advantages can be achieved hereby. Using driving environment information that is present or retrievable by the computing device external to the motor vehicle provides a better basis for assessing the completely autonomous operation of the motor vehicle by the person carrying out the monitoring. In particular, it is thus possible, for example, to deactivate the autonomous driving function upon detection of dangerous situations by the person carrying out the monitoring and, if necessary, to transfer the motor vehicle into a safe state or to impose a different intervention, as a result of which the safety is increased. Finally, by using the central monitoring device, in particular by using a human person carrying out the monitoring, and the driving environment information, additional experience and additional knowledge can be introduced, in order to ensure the safety and reliability of the autonomous driving function and the use thereof in an improved manner.

As already mentioned, in a preferred embodiment, the or one possible item of intervention information can describe a deactivation of the completely automatic guidance by the vehicle system as an intervention. In this connection, it is provided in a particularly advantageous embodiment of the present disclosure that, in order to operate the motor vehicle according to the intervention information describing the deactivation of the completely automatic guidance by the vehicle system, a driver takeover request is output, the completely automatic guidance being ended when the driver takes over, or, if the driver does not take over, the motor vehicle is transferred into a safe state, in particular standstill and/or in a controlled manner to a safe location. In this way, it is first attempted to resort to the driver as a fallback level, then next, if the driver is not available as a fallback level, the motor vehicle is brought into a safe state, i.e. in particular is parked at a safe location, for example on a breakdown lane or on the side of the road.

In a particularly advantageous development of the present disclosure, it can be provided that, in the case of a driver input in the motor vehicle relating to an activation of the completely automatic guidance by the vehicle system, an item of request information which comprises an item of case information describing a driving environment provided for the completely automatic guidance, and the at least one item of location information containing the current position of the motor vehicle, is transmitted to the computing device, an item of permission information is determined from the request information and the driving environment information and is displayed on the display device, an item of response information describing granting or rejection of the activation being received by the person carrying out the monitoring, via the input device, and being returned to the motor vehicle, the completely automatic guidance by the vehicle system being activated only in the case of an item of response information indicating granting. In this advantageous extension of the present disclosure, the central monitoring device can thus also be used to assist in the decision of whether or not the autonomous driving function can be activated, and in doing so to use its additional knowledge and its additional experience. In particular, it is thus possible to prevent the autonomous driving function from being switched on upon detection of dangerous or unsafe situations, for example if a risk of an error in the completely automatic guidance of the motor vehicle by the vehicle system is increased due to the calculation device-side driving environment information, a danger point unknown in the motor vehicle is present, or the like.

Particularly advantageously, the intervention information and/or the response information indicating a rejection can comprise an item of reason information determined from an input of the person carrying out the monitoring, which is output to the driver of the motor vehicle. In this way, the driver of the motor vehicle is always also informed of the cause for a decision for an intervention in the active autonomous driving function or against activation of the autonomous driving function, so that on the one hand said driver is better informed, but on the other hand, because the motivation for the corresponding intervention information or response information is known, a generally increased acceptance of the decisions of the person carrying out the monitoring is achieved. In addition, however, if the reason information relates to the driving environment, the driver can rather pay attention to specific hazards and/or other circumstances, for example, during their own operation of the motor vehicle, such that an increase in safety also follows in this regard. If, for example, there are unusual weather conditions are on a route portion ahead, which have not yet been traveled through or have not yet been traveled through sufficiently often by the autonomous driving function, or there is a rare traffic situation involving a particular hazard, this can be set out to the driver in the reason information, such that said driver can also pay attention to the particular circumstances. However, causes, for example errors and/or discrepancies, in the vehicle system itself can also be communicated to the driver, possibly also with advice to visit a workshop or the like. For inputting the reason information by the person carrying out the monitoring, it can be provided, for example, that said person selects one aspect of the status information which can form a component of the reason information and/or is linked to at least a portion of the reason information.

In an expedient embodiment of the method, provision can be made for the status information to be determined comprising a safety prediction value, which is in particular related to a scale and determined within the framework of the evaluation. The safety prediction value can be output, for example, in a or the scale and/or color coded on the display device. Such a safety prediction value can, for example, be a probability for safe travel or the like. Then, for example, a type of “probability bar” can be displayed in the display of the status information, which bar can also be colored accordingly for different probability ranges, for example red at low probabilities, yellow at average probabilities and green at high probabilities. In this case, the determination of the safety prediction value can in particular be based on usage data of the autonomous driving function of the vehicle system which describe the use in the past. Thus, for example, an evaluation can be derived on the basis of comparable driving environments/driving situations, of how high the degree of safety is in the completely automatic guidance of the motor vehicle.

Expediently, the location information also contains a current direction of travel and/or at least a part of a future route of the motor vehicle. As a result of the vehicle information describing the current direction of travel, it is possible to determine which driving environment is at least immediately ahead of the motor vehicle, possibly also further ahead in the case of a journey on a freeway. If a navigation system within the motor vehicle is already used, this can provide the route to be traveled on in the future, as also for the autonomous driving function. It is also conceivable to obtain further information about the future driving environment, in which the autonomous driving function is used, from other vehicle systems. It is also conceivable in this connection to predict the most probable future route, if the driver has not yet indicated a current journey destination. For example, on a motorway, if the completely automatic vehicle guidance, i.e. the autonomous driving function, is activated, it is to be expected that the driver wishes to remain on the freeway for some time.

In a particularly advantageous development of the present disclosure, it can be provided that the vehicle information, specifically the guidance information, comprises at least one sensor data set, in particular a camera image, of at least one environment sensor of the motor vehicle, and/or at least one sensor data set, in particular a camera image, is transmitted from the motor vehicle to the computing device in response to request information transmitted in a manner initiated by the person carrying out the monitoring. The sensor data set, in particular when it is a camera image, can preferably be displayed as being assigned to/associated with the status information, such that the person carrying out the monitoring can make a direct image of the circumstances in which the motor vehicle is operated at the present time. In this case, the sensor data set can already be evaluated at least in part, for example as an annotated camera image, a surroundings map determined by sensor data fusion of a plurality of environment sensors, and the like. The sensor data set particularly advantageously also relates to sensor data used in the completely automatic guidance of the motor vehicle, such that, in particular when the person carrying out the monitoring receives access to these sensor data directly or indirectly, it is possible to identify more intuitively what the vehicle system, in particular the autonomous driving function, has to deal with. This can also specifically, for example if the usual status information is not sufficient for making a decision, be requested by the person carrying out the monitoring, in particular as described, by means of the request information. This results in a significantly improved basis for a decision and, if the sensor data set is processed in the evaluation, also a significantly better basis for determining the status information. As already mentioned, the use of a camera image, in particular front camera image, is particularly preferred in this case, since specific circumstances, for example visibility conditions, weather conditions, traffic density and the like, are directly apparent therefrom, when the camera image is displayed as part of the status information. If the person carrying out the monitoring identifies, for example, extremely adverse weather conditions, such as a significant storm or snowfall, a deactivation of the completely automatic vehicle guidance and a transfer to the driver can be initiated.

In this case, it should also be noted at this point that useful guidance information as vehicle information also relates to an indication of traffic density in the current surroundings of the motor vehicle, since such information is usually determined anyway within motor vehicles having a suitable sensor system and/or communication ability. For example, traffic density information can be determined by environment sensors and/or motor vehicle-to-motor vehicle communication. In general, it can be said that the complexity of the traffic situation increases with increasing traffic density, which can be expedient, for example, in the determination of a safety prediction value, in particular a probability for a safe trip, but also provides a useful decision support for the person carrying out the monitoring, as part of the status information.

Preferably, the vehicle information, in particular the guidance information, can comprise at least one item of error information which describes an error which has occurred and/or is possible during the completely automatic guidance of the motor vehicle. Such error information can be provided, for example, by a monitoring module of the vehicle system. Such a monitoring module can, for example, perform a plausibility check of vehicle guidance measures, i.e. in particular output data of the algorithm of the autonomous driving function, and/or determine irregularities in another manner. If the completely automatic guidance of the motor vehicle, as described at the outset, is realized over a plurality of independently usable paths, it is possible, for example, to switch between them by means of the monitoring module, and/or the paths can be used at least in part for mutual plausibility checking of their input data. In the embodiment comprising a plurality of paths, as an alternative or in addition to such error information, in particular of a monitoring module, data of the individual paths can be incorporated into the guidance information and transmitted to the computing device, where said device can assume the function of such a monitoring module at least in part, with respect to the determination of the status information. In addition to the monitoring module mentioned by way of example, other diagnostic modules of the vehicle system can of course also be used, for example vehicle diagnostic data which can contain error information or form the basis thereof, as part of the guidance information of the vehicle information. General vehicle diagnostic data can also be part of the guidance information. In this way, indications of other defects and/or unusual states in the motor vehicle can also be obtained by the computing device external to the motor vehicle and taken into account in the central monitoring device.

In an expedient development of the present disclosure, it can be provided that at least one information element of the vehicle environment information is determined from an item of vehicle information and/or a sensor data set of at least one further motor vehicle, by the computing device. This means that, in such an embodiment, the monitoring system according to the present disclosure can also take into account findings relating to the operation of subsequent motor vehicles obtained from other motor vehicles traveling ahead, for example. Therefore, information elements of the vehicle environment information can be derived from data supplied by the entire monitored vehicle fleet or even from other motor vehicles. If, for example, a preceding motor vehicle that uses the autonomous driving function or does not use the autonomous driving function determines that there is a dangerous situation, in particular such a situation that the autonomous driving function cannot deal with safety, said vehicle can supply corresponding data to the computing device, which device associates said data with the current driving environment of the reporting motor vehicle and derives a corresponding item of driving environment information for subsequent motor vehicles which also want to use this driving environment. Such an information element can of course also be updated on the basis of more current vehicle information and/or sensor data sets and/or other data of further motor vehicles. In this way, it is in particular also possible to prevent errors, which have occurred in the case of a preceding motor vehicle, in the case of subsequent motor vehicles. However, even if an error or the like does not occur directly, useful information can result, for example if a first motor vehicle detects an object on the roadway, whereupon the presence of this object can be taken into account with respect to subsequent motor vehicles.

Generally speaking, the driving environment information can expediently comprise an item of weather condition information and/or an item of visibility interference information and/or an item of traffic obstruction information and/or an item of danger point information and/or an item of non-suitability information regarding the vehicle system. Non-suitability information can relate, for example, to the presence of traffic situations or driving situations which would be new for the vehicle system, specifically the autonomous driving function, and/or are known as malfunctions. Weather condition information, in particular, for assessing the danger of a driving environment to be used for the autonomous driving function, can comprise, for example, information about snow, black ice, heavy rain, hail, fog, storms and the like, and can for example be provided by a weather service or else derived from data of other motor vehicles, as described. The same applies to visibility interference information, which can relate, for example, to fog, backlight and the like. Danger point information can relate, for example, to persons and/or animals on the roadway, persons disturbing road events, building sites, broken-down road users, accidents, emergency vehicles, lost loads, road damage, heavy haulage, road sign errors and the like. Further examples which can be described by driving environment information of the type mentioned are burning objects on the roadway, smoke development and generally poor light conditions. In this case, as described, preferably at least in part information elements are derived from data, in particular vehicle information and/or sensor data sets, of other motor vehicles.

In an expedient development, when determining the status information and/or the permission information, an artificial intelligence algorithm can be used, in particular for determining the safety prediction value. Such an artificial intelligence algorithm can, for example, be trained from the past on the basis of the already mentioned usage data relating to the autonomous driving function. In this way, the advantages of human intelligence (person carrying out the monitoring) and artificial intelligence (algorithm) can be combined with particular synergy. The artificial intelligence algorithm can be, for example, a neural network, in particular a convolutional neural network (CNN).

In a particularly advantageous development of the present disclosure, it can be provided that a person carrying out the monitoring is assigned a plurality of motor vehicles to be monitored. This can take place in particular in that status information for a plurality of motor vehicles to be monitored is displayed on at least one of the at least one display device, in particular for a group of motor vehicles which are located in a common geographical area and/or within a specific driving environment, for example a specific length portion of a freeway. For this plurality of motor vehicles, the person carrying out the monitoring then receives the corresponding status of the various motor vehicles they are to monitor, on the basis of the status information. In this connection, but also independently thereof, it is particularly advantageous if the status information is displayed in the manner of a dashboard. In this way, the status information can be evaluated particularly easily by human intelligence. This results in an excellent overview of a plurality of motor vehicles to be supervised or monitored.

By using a single person carrying out the monitoring, for a plurality of motor vehicles to be monitored, a low-cost implementation of a basic monitoring is provided, in which the person carrying out the monitoring ultimately has to mainly question whether the use of the autonomous driving function, i.e. the completely automatic guidance of the motor vehicle, is sensible or sufficiently error-resistant in the current driving situation and/or the current or upcoming driving environment. If a use of the autonomous driving function is not identified as expedient, this can be deactivated by means of corresponding intervention information, if it was already activated, or the activation can be disallowed in the first place (response information). In this case, it is therefore the task of the person carrying out the monitoring to deactivate the autonomous driving function and/or to prevent activation, in the central monitoring device, when abnormal states are detected.

In addition to the method, the present disclosure also relates to a monitoring system for monitoring at least one motor vehicle, which has a vehicle system designed for completely automatic guidance of the motor vehicle, and a communication device designed for communication with a remote computing device external to the motor vehicle, the monitoring system being designed to carry out the method according to the present disclosure. All the statements relating to the method according to the present disclosure can therefore be applied analogously to the monitoring system according to the present disclosure, by means of which the aforementioned advantages can therefore also be achieved.

The communication device can in particular be designed to establish a communication connection from the motor vehicle to the motor vehicle-external, remote computing device at least in part via a mobile radio network and/or the Internet. Modern motor vehicles frequently already have a communication device of this type, which registers the motor vehicle in at least one mobile radio network and thus provides communication options for different vehicle systems.

Additional advantages and details of the present disclosure are shown in the embodiments described hereinafter and from the drawings.

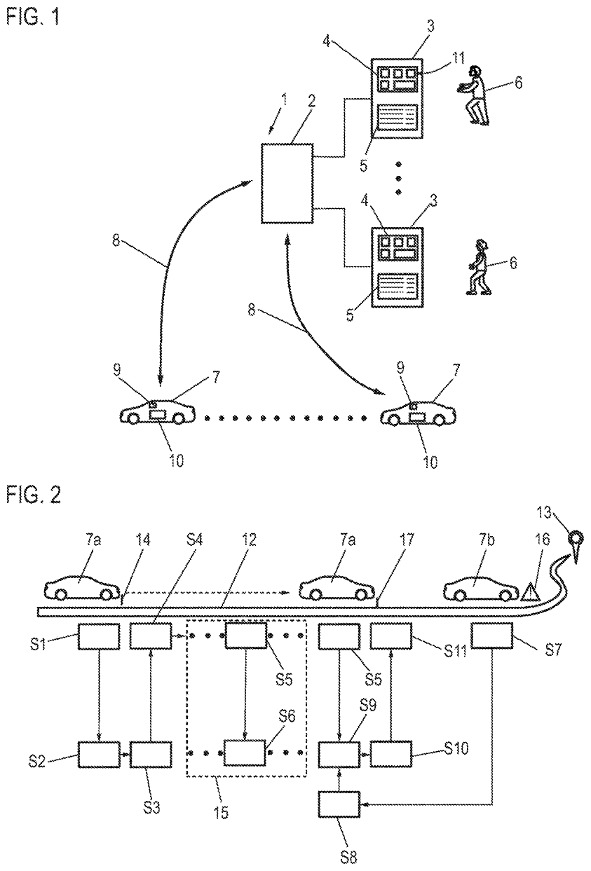

FIG. 1 shows a schematic view of a monitoring system 1 according to the present disclosure. The monitoring system 1 comprises a central computing unit 2, for example at least one server, which is permanently installed at a central location, which can also be referred to as “central monitoring device.” A plurality of workstations 3, each comprising a display device 4 and an input device 5, are connected to the computing device 2. A person carrying out the monitoring 6 can work at each of the workstations 3, which can also be referred to as monitoring stations.

The computing device 2 communicates with a plurality of motor vehicles 7 by means of corresponding communication connections 8 which, for example, can use a mobile radio network and/or the Internet at least in part. In order to establish the communication connections 8, each of the motor vehicles has a communication device 9, which is connected inside the vehicle inter alia to a vehicle system 10, which is designed for completely automatic guidance of the respective motor vehicle 7 within the framework of an autonomous driving function.

If the autonomous driving function of the vehicle system 10 is active, the motor vehicles 7 cyclically send an item of vehicle information to the computing device 2. The vehicle information comprises an item of guidance information which relates to the completely automatic guidance of the motor vehicle 7, along with an item of location information which in the present case also contains, in addition to a current position of the respective motor vehicle 7, for example determined by a GPS sensor and/or defined in a digital map, a direction of travel and, at least in portions, the future route of the motor vehicle 7. In the present case, the guidance information comprises, for example, in addition to the activation status of the autonomous driving function, at least one sensor data set, in the present case comprising an image of a front camera of the respective motor vehicle 7, traffic density information, and operating data of the vehicle system 10, which can in particular comprise error information which indicates an existing error and/or a possible error in the vehicle system. In general, however, in this regard, data relating to different paths usable for completely automatic vehicle guidance can also be included in the vehicle system 10. Of course, a plurality of further items of vehicle information, in particular guidance information, are also conceivable, for example a current speed of the motor vehicle 7, vehicle diagnostic data, also of other components of the motor vehicle 7, and the like. Furthermore, the guidance information can also include traffic density information.

The transmitted vehicle information for each vehicle is evaluated in the computing device 2 together with an item of driving environment information that can be associated with the location information, in order to determine compact, intuitive and understandable status information which can be displayed on the display device 4 of a workstation 3 for the corresponding person carrying out the monitoring 6. The driving environment information usable in the computing device 2 contains at least in part information elements which are derived from data of other motor vehicles 7, in particular from vehicle information of other motor vehicles 7 and/or sensor data sets of other motor vehicles 7. Driving environment information can generally comprise weather condition information and/or visibility interference information and/or traffic obstruction information and/or danger point information and/or non-suitability information with respect to the vehicle system 10, assigned in each case to particular route portions and/or locations. If, for example, it is identified in a front camera image of one of the motor vehicles 7 that unfavorable weather conditions, for example heavy snow and/or visibility interference, are present, a corresponding item of weather condition information/visibility interference information can be derived and assigned to the driving environment according to the current location information of the reporting motor vehicle 7. Traffic obstacles and/or danger points, for example objects on the roadway, can be determined accordingly. Non-suitability information can relate to traffic situations which are new for the vehicle system 10 and/or for which malfunctions are known or have already become known by the reporting motor vehicle 7. Such derived driving environment information, which can of course be updated, can then also be taken into account when assessing the status of subsequent motor vehicles 7 or generally other motor vehicles 7. Of course, driving environment information can also include information elements originating from other sources, for example weather condition information of a weather service and/or traffic flow information of a traffic control center.

In the present case, the status information is also determined by the computing device 2 so as to comprise a safety prediction value which, for example, can be a probability for a safe trip. For this purpose, as well as for determining other information elements of the status information, an artificial intelligence algorithm can also be used, which can be trained, for example, on the basis of usage data of the autonomous driving function from the past.

The status information is displayed to the person carrying out the monitoring 6 in the manner of a dashboard 11 on the display device 4. Said person assesses, on the basis of the status information, whether a continuation of the operation of the autonomous driving function for the corresponding motor vehicle 7 is sensible, and optionally uses the input device 5 to input an intervention to be performed in the completely automatic vehicle guidance. A corresponding item of input information is generated and transmitted from the computing device 2 back to the corresponding motor vehicle 7 via the corresponding communication connection 8, where the motor vehicle 7 is operated for performing the intervention described by the intervention information. In this case, the intervention information in particular relates to the deactivation of the completely automatic guidance of the motor vehicle 7 as an intervention. In principle, however, other intervention information comprising other interventions is also conceivable, for example the switching of the operating mode of the autonomous driving function to a more cautious driving mode and/or even the transfer of the motor vehicle 7 into a safe state.

If the motor vehicle 7 receives an item of intervention information relating to the deactivation of the autonomous driving function, a driver takeover request is first output to the driver. If said driver takes over, the motor vehicle is then guided further by the driver, as usual. However, if no driver takeover request is made, the motor vehicle 7 can be transferred, for example according to an action plan, into a safe state, in particular standstill or in a controlled manner to a safe location.

In this case, a plurality of motor vehicles 7 to be monitored are assigned to a person carrying out the monitoring 6, the status information of which vehicles is displayed accordingly on the display device 4. If motor vehicles 7 in which the autonomous driving function is currently not activated also transmit vehicle information, status information must not necessarily be derived herefrom by the computing device 2, but rather it is conceivable that the vehicle information thereof is evaluated only for determining driving environment information, as described.

If a driver of a motor vehicle 7 wishes to activate the completely automatic guidance of the motor vehicle 7, an item of request information is first compiled which, in addition to the location information already described, also comprises an item of case information describing the driving environment provided for the completely automatic guidance. This request information is also transmitted via the communication connection 8 to the computing device 2, which device evaluates said information together with the driving environment information that can be assigned to the location information, in order to determine an item of permission information. The permission information is displayed on the display device 4, an item of response information describing granting or rejection of the activation of the autonomous vehicle function being requested by the person carrying out the monitoring 6 and being accepted via the input device 5. The response information is transmitted back to the corresponding requesting motor vehicle 7, the completely automatic guidance by the vehicle system 10 being activated only in the case of response information displaying permission.

Intervention information and at least rejecting response information in each case also comprise an item of reason information determined from an input by the person carrying out the monitoring 6, which information is output to the driver of the respective motor vehicle 7 in order to make clear to said driver the motivation for the refusal of the activation of the autonomous vehicle function and/or for the deactivation thereof/other interventions, for example. In addition, the driver can adapt his driving behavior if necessary, with respect to the reason information.

FIG. 2 shows, by way of example, flow diagram of the method according to the present disclosure, as said method can be carried out by the monitoring system 1. In this case, one of the motor vehicles 7, here the motor vehicle 7a, is already traveling on a freeway 12. A further motor vehicle 7b of the motor vehicles 7 is traveling in front of the motor vehicle 7a. For example, the motor vehicle 7a wishes to reach a destination 13.

At a point in time at a first position 14 of the freeway 12, the driver decides he would like some rest, and therefore decides to activate the autonomous driving function of the vehicle system 10. In step S1, for example after an actuation of a corresponding control element by the driver, the described request information is compiled and transmitted to the computing device 2, which, in a step S2, determines the permission information by evaluation with the driving environment information, and displays said permission information on the display device 4. When determining a probability for a safe trip, the permission information can, for example, be: “Request for activation from motor vehicle 7a on the freeway 12, position 14; weather situation ok; malfunctions of the autonomous driving function: not present; probability for safe travel: 99.99%; person for monitoring travel present—permit or deny?”. In this case, the probability for a safe trip, as a safety prediction value, is advantageously displayed as a scale value and color-coded, for example as green, in this case almost completely filled, bars. In addition, if a corresponding sensor data set has been transmitted, a current image of the front camera can be displayed. The person carrying out the monitoring 6 makes their decision, in this case to allow the activation, such that the corresponding response information is compiled in step S3 and transmitted back to the motor vehicle 7a, which correspondingly activates the completely automatic guidance of the motor vehicle 7a in a step S4.

In a time range 15, the vehicle information is now cyclically transmitted and a corresponding current item of status information is determined by the computing device, which is always shown currently on the display device 4, such that ongoing monitoring by the person carrying out the monitoring 6 can take place. This is indicated by the steps S5 (compilation and transmission of the vehicle information) and S6 (determination and display of the status information).

However, in between, the other motor vehicle 7b has arrived at a danger point 16 where, for example, tension belts are lying on the freeway 12. The motor vehicle 7b also transmits a corresponding item of vehicle information in step S7, which is evaluated in a step S8, by the computing device 2, to form an information element of the driving environment information for the freeway 12, which is added according to the driving environment information. At this time, the motor vehicle 7a is located at a position 17 behind the motor vehicle 7b and transmits its vehicle information, as is usual, in a cycle according to step S5. However, the determination of the status information in step S9 now also includes the new driving environment information, such that the status information can now, for example, additionally contain the following text: “Tensioning belts on the roadway are located on the freeway 12 at danger point 16. Motor vehicle 7a is a kilometer from the danger point 17.” The probability for safe travel can decrease accordingly.

The person carrying out the monitoring 6 now recognizes that it could be useful if the driver maneuvers around the danger point 16 himself, and generates an item of intervention information, which describes a deactivation of the autonomous driving function as an intervention, by means of a corresponding input in step S10. In addition, a reduction in the speed of the motor vehicle 7a can also already be included as an intervention, in order to provide more time for a driver takeover. The intervention information is transmitted to the motor vehicle 7a which, in a step S11, correspondingly reduces the speed and outputs a driver takeover request, with the reason that the danger point 16 is a kilometer ahead (reason information). If the driver takes over, he now continues the control of the motor vehicle 7a manually; if the driver does not take over, the motor vehicle 7a is transferred into a safe state, in particular standstill. In this case, at the latest when the motor vehicle 7a approaches the danger point 16, the camera images thereof (if necessary specifically requested, if not transmitted in any case as a sensor data set) are also evaluated, in order to confirm the danger point 16. For example, five minutes before the danger point in each case a driver takeover can now also be recommended for all subsequent vehicles.

1.-15. (canceled)

16. A method for monitoring a motor vehicle having a vehicle system and a communication device, the vehicle system configured to guide the motor vehicle with completely automatic guidance, and the communication device configured to communicate with a remote computing device outside the motor vehicle, the method comprising:
transmitting to the remote computing device:
an item of vehicle information that comprises an item of guidance information describing the completely automatic guidance, and
an item of location information comprising a current position of the motor vehicle;
evaluating the item of vehicle information together with an item of driving environment information present at the remote computing device and related to the current position of the motor vehicle, the evaluating including forming an item of status information of the motor vehicle;
displaying, on a display device, the item of status information to a person, the person carrying out monitoring;
receiving, via an input device assigned to the display device, an intervention information from the person carrying out the monitoring;
transmitting, upon receipt of the item of intervention information, back to the motor vehicle, the intervention information; and
operating the motor vehicle by intervening, based on the intervention information, in the completely automatic guidance of the motor vehicle,
wherein the transmitting, evaluating, displaying, receiving, transmitting and intervening are performed in a cyclic manner during the completely automatic guidance of the motor vehicle by the vehicle system.

17. The method of claim 16, wherein the intervening comprises deactivating the completely automatic guidance by the vehicle system.

18. The method of claim 16, wherein operating the motor vehicle based on the intervening further comprises:
either:
outputting a driver takeover request in accordance with the intervention information describing the deactivation of the completely automatic guidance by the vehicle system; and
ending the completely automatic guidance in response to a driver taking over operation of the motor vehicle;
or:
ending the completely automatic guidance in response to a driver not taking over operation of the motor vehicle and transferring the motor vehicle to a safe state wherein the safe state comprises a standstill state or a safe location.

19. The method of claim 16 further comprising:
in a case of a driver input in the motor vehicle, relating an item of case information to an activation of the completely automatic guidance by the vehicle system, the item of case information describing the driving environment provided for the completely automatic guidance;
transmitting the location information to the remote computing device;
determining an item of permission information from a request information and the driving environment information;
displaying the determined item of permission information on the display device;
receiving by the person carrying out the monitoring, an item of response information describing granting or rejection of the activation via the input device;
returning the item of response information to the motor vehicle; and
activating, by the vehicle system, the completely automatic guidance in response to an item of response information indicating granting of the activation.

20. The method of claim 16, further comprising outputting, to the driver of the motor vehicle, the intervention information and/or a response information indicating a refusal comprising an item of reason information determined from an input of the person carrying out the monitoring.

21. The method of claim 16, further comprising determining within a framework of evaluation, the item of status information comprising a safety prediction value based on a scale.

22. The method of claim 21, further comprising outputting the safety prediction value on a scale and/or color coded on the display device.

23. The method of claim 19, wherein in response to transmitting the request information by the person carrying out the monitoring, the method further comprises transmitting, from the motor vehicle to the remote computing device, the vehicle information, the vehicle information comprising at least one sensor data set, wherein the at least one sensor data set comprises a camera image of at least one environment sensor of the motor vehicle.

24. The method of claim 16, further comprising describing an error, using at least one item of error information in the vehicle information, wherein the error has occurred and/or is possible, in the completely automatic guidance of the motor vehicle

25. The method of claim 23, further comprising determining at least one information element of the vehicle environment information from an item of vehicle information and/or a sensor data set of at least one further motor vehicle.

26. The method of claim 21, further comprising using an algorithm of artificial intelligence for determining the status information and/or the permission information, wherein the status information and/or permission information is the safety prediction value.

27. The method of claim 16, further comprising using at least one of an item of weather condition information or an item of visibility restriction information, an item of traffic obstruction information, an item of danger point information, or an item of non-suitability information regarding the vehicle system as the driving environment information.

28. The method of claim 16, further comprising assigning a person a plurality of motor vehicles to be monitored.

29. The method of claim 16, further comprising displaying status information on a dashboard.

30. A monitoring system for monitoring a motor vehicle, the monitoring system having a vehicle system configured for completely automatic guidance of the motor vehicle, and a communication device configured for communicating with a remote computing device external to the motor vehicle, the monitoring system being configured to:
cyclically transmit, to the remote computing device, during the completely automatic guidance of the motor vehicle by the vehicle system,
an item of vehicle information that comprises an item of guidance information describing the completely automatic guidance, and
an item of location information comprising at least one current position of the motor vehicle;
evaluate the item of vehicle information together with an item of driving environment information present at the remote computing device and related to the position of the motor vehicle, the evaluating including forming an item of status information of the motor vehicle;
display, on a display device, the item of status information to a person carrying out the monitoring;
receive, via an input device assigned to the display device, an intervention information from the person carrying out the monitoring;
transmit, upon receipt of the intervention information, back to the motor vehicle, the intervention information; and
operate the motor vehicle, by intervening, based on the intervention information, in the completely automatic guidance of the motor vehicle.
